(19) United States
(12) Patent Application Publication
(10) Pub. No.: US 2006/0114421 A1
(43) Pub. Date: Jun. 1, 2006

(54) Image projector with a two-dimensional array of light-emitting units

(75) Inventors: Anthonie Hendrik Bergman, Eindhoven (NL); Frank Anton Van Abeelen, Eindhoven (NL); Ramon Pascal Van Gorkom, Eindhoven (NL); Albericus Antonius Maria Hoevenaars, Eindhoven (NL); Boris Skoric, Eindhoven (NL); Nijs Cornelis Van Der Vaart, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,026

(22) PCT Filed: Nov. 27, 2003
(86) PCT No.: PCT/IB03/05501

§ 371 Date: Jun. 15, 2005

(30) Foreign Application Priority Data
Dec. 20, 2002 (EP) 02080514.9

(51) Int. Cl. G03B 21/26

(52) U.S. Cl. 353/94

(57) ABSTRACT

The invention relates to a method of providing images on a screen and to an image projection device. The image projection device (10) comprises at least one first set (12) of light-emitting units provided in an array including at least two lines of light-emitting units having at least two light-emitting units each, and a light-displacing unit (36) arranged to displace the light from each light-emitting unit before projection on a screen (16), such that each light-emitting unit provides a tile comprising a line including at least two pixels aligned in one direction on the screen. The light-emitting units are preferably LEDs, and in this way, an efficient display or projector that can be accommodated in a reasonably small space is provided.

### FIELD OF THE INVENTION

The present invention generally relates to the field of projecting images on screens and more particularly to a method and device for providing images on a screen.

### BACKGROUND OF THE INVENTION

Within the area of displays, there is a constant search for improved displays, as many current types are either bulky, costly or inefficient.

Some types of displays like LCDs (Liquid Crystal Display) have a technique with a continuous lamp source and shutters where light is always generated. This is not efficient. Even though the light is attenuated afterwards, LCDs often need color filters in order to provide colors, which lowers the efficiency of the device even more so that it needs more energy to work satisfactorily.

Another type of display only generates light when needed on a pixel basis. One example of this type of device is a CRT (Cathode Ray Tube). However, this device needs vacuum in order to work and therefore requires, among other things, a thick glass envelope.

Other types of displays are plasma displays. They are, however, still very expensive and have a low efficiency.

One type of light source having good properties for displays is a LED (Light-Emitting Diode). The LED is in itself quite small, can be controlled to switch on and off in a fast manner and also provides good colors at a high efficiency. There is one drawback with LEDs though, and that is that they need a big housing round each LED, which has led to the use of LEDs so far being limited to large billboards and giant screens.

There have been some attempts to reduce the number of LEDs used. WO 01/29808 shows how an array of red, green and blue LEDs is scanned onto a screen using a rotating mirror. Here, the array includes one column of green LEDs, one column of red LEDS and one column of blue LEDs in a first variation. Each column is then scanned with the aid of the mirror so that each combination of red, green and blue diodes provides one row of pixels. In a second variation of this array, there are two columns of each color LED, which are slightly displaced from each other in the vertical direction, where the LEDs of the additional column of a color provide the light for every other row of the screen. The first variation is bulky, because of the length of the columns. The second variation has halved the length, but is still quite bulky. Both these solutions have in common that the array of LEDs is one-dimensional. Each LED provides all the pixels for one row. This means that scanning of a row in the device uses one LED of one color. The mirror used must also be quite large, which adds to the cost of the device. The document WO-01/29808 also describes the use of two mirrors in order to scan three LEDS, one for each color, across a screen in both a horizontal and a vertical direction. Here, there is no array at all. Because of the large areas scanned in a direction, the image may be distorted. The mirrors also have to be rotated fast, which might be hard to accomplish.

There is thus a need for an array that can be made smaller, needs only small displacements of light incident on a screen so that distortion of projected images is avoided and allows the use of a lower rotational speed for displacing the light on a screen than in existing devices and methods.

### OBJECT AND SUMMARY OF THE INVENTION

It is an object of the present invention to provide smaller displacements of light incident on a screen from a two-dimensional small array of light-emitting units so that distortion of projected images is avoided, and which allows the use of a lower rotational speed for displacing the light on a screen, for example, by using more facets.

According to a first aspect of the present invention, this object is achieved by a method of providing images on a screen, the method comprising the steps of:
emitting light from a first set of light-emitting units provided in a two-dimensional array having at least two lines of light-emitting units, each line including at least two light-emitting units,
projecting the light from said first set of light-emitting units on the screen, and
displacing the light projected on the screen from each light-emitting unit, such that each light-emitting unit provides a tile of the screen including at least two pixels in a line aligned in one direction on the screen.

According to a second aspect of the present invention, this object is also achieved by an image projection device comprising:
at least one first set of light-emitting units provided in an array including at least two lines of light-emitting units having at least two light-emitting units, and
a light-displacing unit arranged to displace the light from each light-emitting unit before projection on a screen, such that each light-emitting unit provides a tile comprising a line including at least two pixels aligned in one direction on the screen.

Claims 3 and 13 are directed towards providing tiles extending also in a vertical direction.

Claims 5, 12 and 16 are directed towards providing a light transmission medium for displacing light from the array of light-emitting units.

Claim 14 is directed towards providing equal displacement from line to line.

Claim 17 is directed towards providing reflective light transmission mediums.

Claims 6 and 20 are directed towards reducing stitching effects.

Claim 18 is directed towards allowing further reduction of an array of light-emitting units if more than one color is used.

The present invention has the advantage of providing a small-sized image display device that at the same time only needs a limited scan range. This limits distortion of projected images and allows the use of a lower rotational speed for displacing the light on a screen. The invention furthermore provides a beneficial form factor and allows the use of means of displacing the light other than mechanical means.

The general idea behind the invention is thus to provide a limited size two-dimensional array of light-emitting units for projection on a screen, where the light from each light-emitting unit is displaced in at least one direction in order to provide a tile of pixels on the screen.

These and other aspects of the invention are apparent from and will be elucidated with reference to the embodiments described hereinafter.

### BRIEF DESCRIPTION OF THE DRAWINGS

The present invention will now be explained in more detail with reference to the enclosed drawings, wherein

FIG. 1 is a schematic drawing of a device according to the invention for projecting images on a screen,

FIG. 2 shows a first set of LEDs provided in an array for projecting light on a screen,

FIG. 3 schematically shows the light from the LEDs in the array of FIG. 1, projected onto the screen,

FIG. 4 schematically shows a light-displacing unit in the form of a light-transmissive wheel,

FIG. 5 shows a first light-displacing characteristic of a segment of the wheel in FIG. 4,

FIG. 6 shows a transflective unit together with first, second and third sets of LEDs for providing an even smaller device,

FIG. 7 shows a flow chart of a method of providing images on a screen according to the invention,

FIG. 8 schematically shows two transmissive units as an alternative to the wheels of FIG. 4,

FIG. 9 shows an alternative reflective wheel, and

FIG. 10 shows two reflective units as an alternative to the reflective wheel.

### DETAILED DESCRIPTION OF EMBODIMENTS

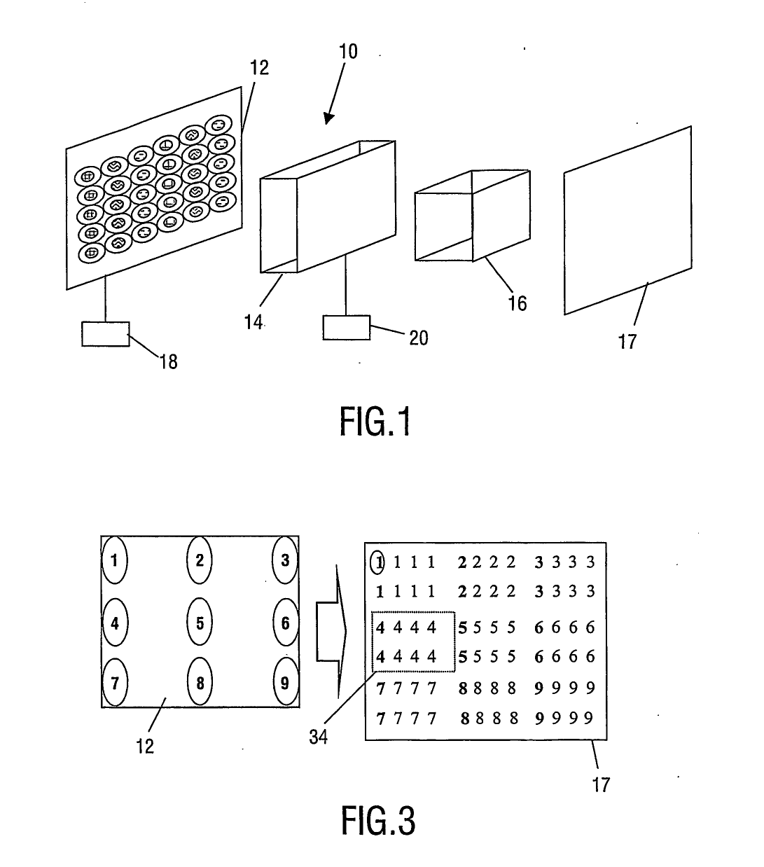

The present invention relates to the provision of images on a screen and more particularly to providing pixels for a screen using an array of light-emitting units that has to be kept small. FIG. 1 generally shows a device for projecting an image on a screen according to the invention. The device 16 is preferably provided in a display and then preferably in a television set. The device can also be provided in a projector, arranged to project images on a large screen. The device 10 includes a first set of light-emitting units 12, which light-emitting units are preferably LEDs (Light-Emitting Diodes) provided in a two-dimensional array or matrix. The LEDs are provided in rows and columns so that each LED in one column is aligned with one LED in each other column and each LED in a row is aligned with one other LED in each other row. The array 12 is connected to control electronics 18 arranged to provide each LED with control signals for turning them on and off in order to provide pixel information to be displayed. The array 12 therefore generates light, which falls onto a light displacing unit 14. The light-displacing unit 14 is connected to a control unit 20 arranged to provide a change of position of the light-displacing unit 14 for displacing the light emitted from all LEDs in the array. After passing the light-displacing unit 14, the light from all the LEDs in the array 12 is projected on a projector unit 16 provided in the form of a projection lens, which projects the light on a screen 17, which screen 17 may be the projector screen provided for a projector by a user or made of a display material, receiving the light from the LEDs on a rear side and displaying information on the front side, when provided in a television set or perhaps in a large computer display.

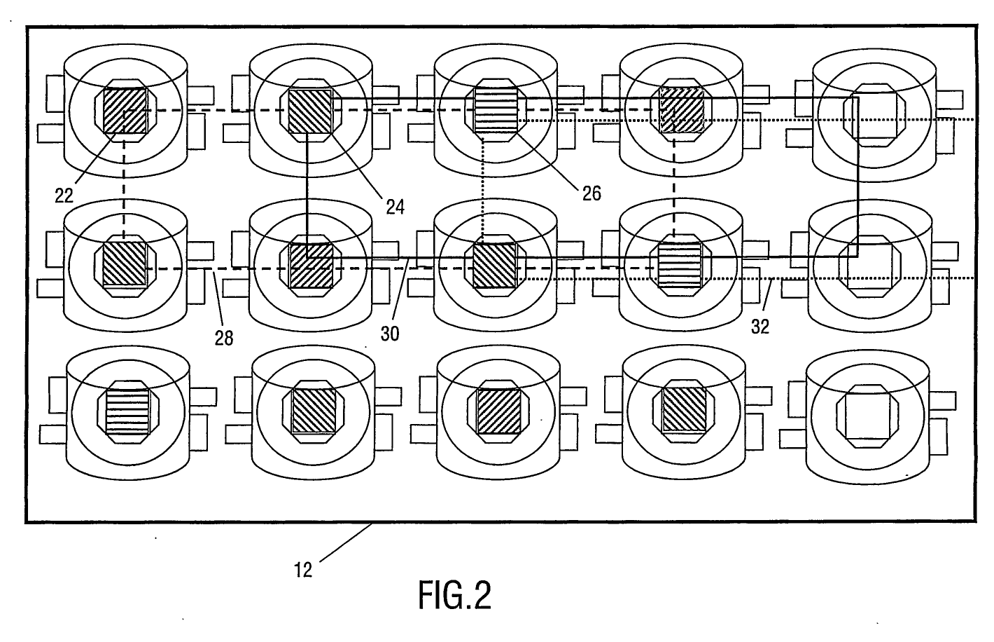

FIG. 2 shows a few LEDs provided in an array 12. Here, there are three types of LEDs, namely a first type 22 providing the color red, a second type 24 providing the color green and a third type 26 providing the color blue. The distance between two LEDs of the first type 22 is indicated by a first box 28 having dashed lines, the distance between two LEDs of the second type 24 is indicated by a second box 30 having solid lines and the distance between two LEDs of the third type 26 is indicated by a third box 32 having dotted lines. The third box 32 is not shown in its entirety in the Figure. As is apparent from the drawing, each LED is covered by a housing for directing the light. These housings are quite large. If the array in FIGS. 1 and 2 had one LED for each color and each such three color-combination was assigned to just one pixel on the screen, the display device would become very large and bulky and it would not be possible to include it in devices such as television sets. Note that the device will become very bulky even if three different colors are not used, i.e. if the device were only to provide pixels in black and white or in gray scale. There is thus a need to limit the number of LEDs used. The invention solves this problem by letting one LED in an array of LEDs provide a tile of pixels in both the horizontal and vertical direction.

FIG. 3 shows how the light from a number of LEDs is projected on the screen 16. The array 12 is here simplified in that it only includes 9 LEDs enumerated 1 to 9 in three rows and three columns, where LEDs 1-3 are provided in a first row, LEDs 4-6 are provided in a second row and LEDs 7-9 are provided in a third row. The LEDs here furthermore only represent one color for better understanding of the invention. It should be realized that there may be two additional LEDs for each shown in FIG. 3. The LEDs are originally projected in a first position on the screen 17, which is indicated by bold numbers 1-9 in rows 1, 3 and 5 on the screen. Then the light from each LED is displaced horizontally in three steps, which is indicated in the right part of FIG. 3 showing the screen with the numbers 1, 2, 3, 4, 5, 6, 7, 8, and being repeated three times in rows 1, 3 and 5, such that these rows are completed. This means that the light from a LED is displaced three times after the original projection. The information that a LED is displaying is, however, varied so that each of the displayed numbers represents a pixel on the screen. This variation of information of a LED is achieved by suitably switching the LED in question on and off by using the control electronics shown in FIG. 1. After these rows 1, 3 and 5 have been scanned, the light from all the LEDs is displaced vertically in one step, starting from a position furthest to the right, i.e. with the bold numbers 1-9 in rows 2, 4 and 6, and the light from the LEDs is scanned in the same way as described above in order to provide the pixels of rows 2, 4 and 6. Each LED therefore provides light for a tile of which one, 34 for LED number 4, is indicated in FIG. 3. Here a LED thus provides the light for 8 pixels in four columns and two rows. The array therefore provides information for all pixels of the screen. The above-described scheme is automatically repeated for all colors. It should furthermore be realized that FIG. 3 is a mere example for understanding the invention. It is often desirable to provide more pixels from one LED both horizontally and vertically so that the array can be made smaller.

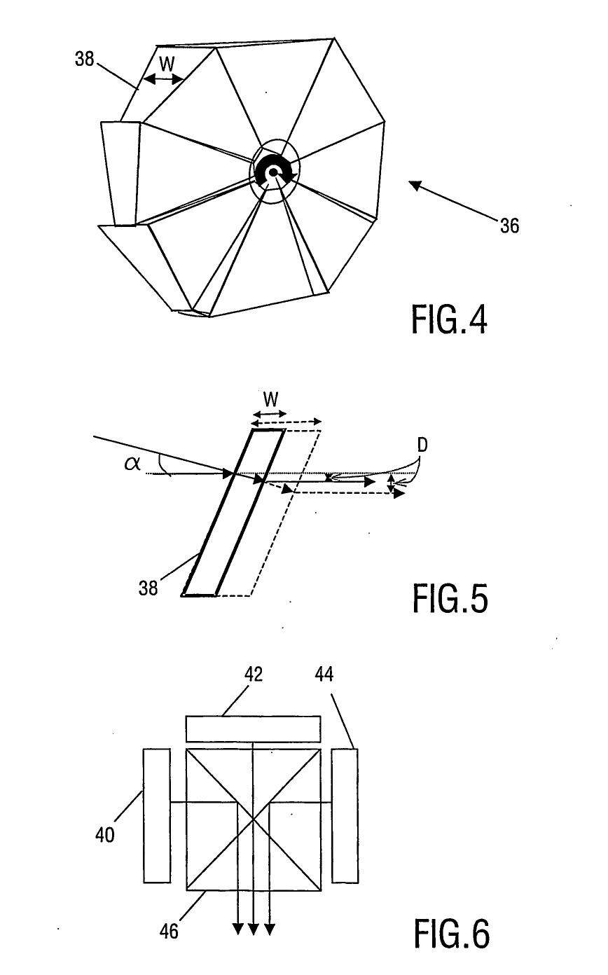

FIG. 4 shows one first preferred variation of a light-displacing unit 14 according to the invention. The Figure shows a wheel 36 of an octagonal shape and having eight segments 38. Light from the LEDs is arranged to be incident on the uppermost segment of the wheel. The segments 38 are provided in the form of a light-transmissive material and can be made of individual prisms. The wheel is made to rotate and, during rotation, the light from the set of LEDs incident on a surface of a segment 38 is displaced upon exiting the segment. Two variables are available for making a certain displacement, namely thickness of material and angle. With these two design freedoms, one can make a wheel to have the desired scan behaviour, e.g. like a CRT. The vertical direction is decided by the width W of a segment 38. FIG. 5 shows the principle behind this width variation. Light incident at an angle α changes direction through the medium because of the different material constants. Since the material has different widths in the horizontal direction, the exit point will differ depending on different entry points. Here, it is worth noting that when angle α is 0 degrees, the displacement is also zero. The light incident upon a surface is displaced with a varying horizontal distance so that all pixels in a line are provided. All segments have the same type of width variation so that displacement in the horizontal direction is the same for all segments. The surface against which light from the LEDs is incident is also angled against the direction of the light in the vertical direction. Each segment has a different angle to the incident light. This means that the angle of incidence will be different for each segment. Each segment 38 therefore displaces the rays of light with a different shift. In this way, the vertical displacement of the light is provided in order to ensure scanning of different rows for the LEDs.

By using the combination of wheel and first array, a sufficiently small-sized display can be obtained that can be included in, for instance, a television set. By using a transmissive wheel, the dimensions of the total device can be kept low, which allows the provision of an even smaller device.

FIG. 6 shows another variation of the invention. The Figure shows three sets of LEDs, 40, 42, 44, one for each color and each providing all the pixels for the screen. These three arrays are provided on three sides of a transflective device or color recombination cube 46 having dichroic reflection properties, i.e. being reflective for light of different colors. One diagonal of the cube provides reflection so that red light from a first array 40 incident on a first side of the cube is reflected inside the cube, and another diagonal of the cube provides reflection of blue light from a third array 44 incident on a third side of the cube. Light from the second array 42 incident upon a second side is passed transparently through the cube 46. In this way, light from the first and third arrays 40, 44 is reflected inside the cube so that it coincides with the light from the second array 42. Therefore, all the light leaves the cube from a fourth side. This light is then provided to the light-displacing unit for projection on the screen. In this way, each array can be smaller or more LEDs can be used and thus a smaller-sized image projection device is obtainable. By virtue of this arrangement, one array can be made three times smaller than the first described array.

An example of an array for providing a VGA (Video Graphics Array) display having 480×600 pixels can be provided by an array having 48 LEDs in the vertical direction and 60 in the horizontal direction. The array is then scanned in an analog fashion in the horizontal direction, where the scan has to be 1/10 of a whole row. Displacements are also performed in 10 steps vertically. It is possible to limit the size of the device even further by providing an array of 12 LEDs in the vertical direction and 15 in the horizontal direction. The scan of the array in the horizontal direction is then 1/12 of a whole row and vertical scanning then has to be effected in 40 steps. When the number of LEDs is diminished, the scan amplitude has to be raised in order to ensure a good performance of the device.

The optimal number of LEDs will be determined by a number of factors, including, among other things, the price of a single LED, the desired image brightness, the allowed scanning range, and the size of the optics.

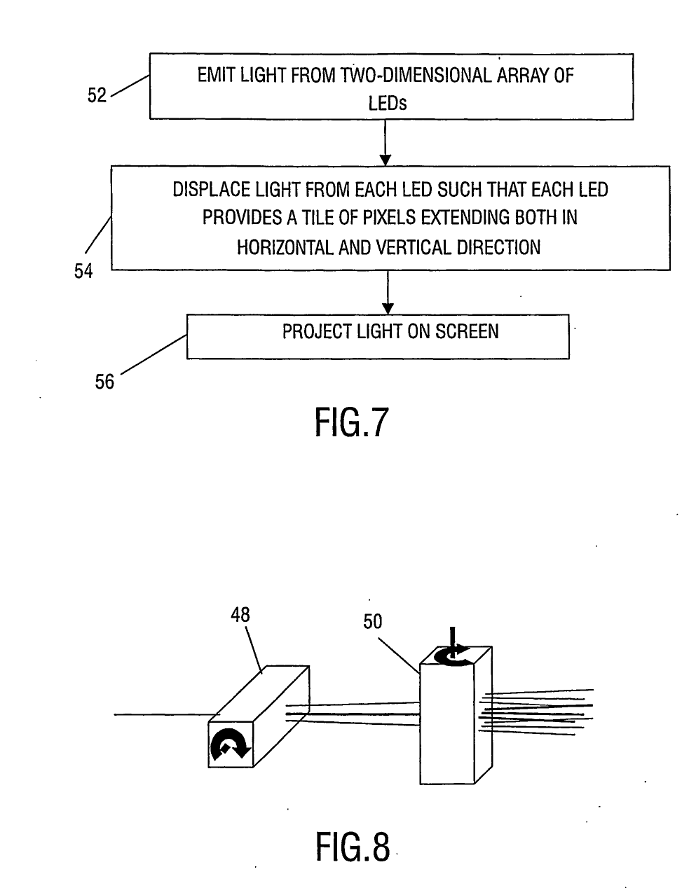

FIG. 7 shows a flow chart of the method according to the invention, which thus can be used to summarize how the invention works. Light from a two-dimensional array of LEDs is emitted (step 52). The emitted light from each LED is displaced in both the horizontal and vertical direction so that each LED provides a tile of pixels in both the horizontal and vertical direction (step 54), whereupon the light is projected onto a screen (step 56).

The invention furthermore reduces stitching effects. By providing a slight overlap between the tiles of two neighbouring LEDs, the stitching effects are reduced. The light intensity of a LED close to a neighbouring tile is provided in the form of a sine wave-shaped attenuation of the original video content by video processing. The light from the LED for the pixel in the neighbouring tile is also provided in the form of a sine wave-shaped attenuation of the original video content also by video processing. The light of the tile is made to overlap such that the original video content is fully restored. Small misalignments of the tiles will now be less visible and stitching effects are reduced in this way.

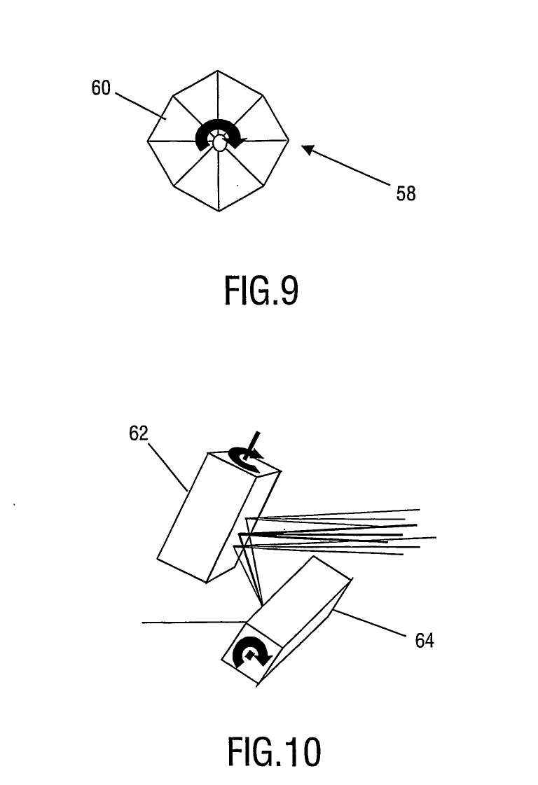

The invention may be varied in many ways, a few of which will be described with reference to FIGS. 8 to 10. FIG. 8 shows a variation of the wheel of FIG. 5. Instead of having one wheel, it is possible to provide two perpendicular bars of transmissive material 48 and 50 rotating around a horizontal and a vertical axis providing vertical and horizontal displacement of the light in accordance with the principles outlined above. However, it is not necessary to use transmissive material in the wheel and bars either, but it is equally well possible to use reflective material. FIG. 9 is a top view of a wheel having an octagonal shape provided with mirrors instead of transmissive material. Each segment here provides different angles of incidence in both the vertical and horizontal direction. One row is scanned by rotation of a segment. The different segments are angled differently in the vertical direction against the light from the LEDs, thus providing different rows as well. FIG. 10 shows another alternative with mirrors, where two rotating mirrors 62 and 64 are used for providing vertical and horizontal scanning. If a wheel is used, it may have more or fewer than eight sides. An octagon provides eight rows, a pentagon five rows, etc.

The number of LEDs used may furthermore be varied in many ways, thus fewer or more tiles than what has been described above can be used according to the invention. The invention is furthermore not limited to LEDs, but may be used in any case where the number of light-emitting units needs to be limited.

The invention has the following advantages. The use of LEDs makes the device more efficient than other types of devices. A limited-size array furthermore provides all of the pixels of a screen through the displacements used. Since a two-dimensional array is used, a better form factor of a projector engine is obtained as compared with a large one-dimensional array solution. Since each LED provides a tile of limited size in the horizontal and vertical direction, it might be possible to use means for providing displacement other than by using mechanical rotation if the number of light-emitting units is large enough. The cube furthermore allows the separation of LEDs of different colors in three different arrays, which makes it possible to reduce the size of a device even further.

1. A method of providing images on a screen, the method comprising the steps of:
emitting light from a first set (12) of light-emitting units provided in a two-dimensional array having at least two lines of light-emitting units (1, 2, 3, 4, 5, 6, 7, 8, 9), each line including at least two light-emitting units, (step 52),
projecting the light from said first set of light-emitting units on the screen, (step 56), and
displacing the light projected on the screen from each light-emitting unit, such that each light-emitting unit provides a tile (34) of the screen including at least two pixels in a line aligned in one direction on the screen, (step 54).

2. A method as claimed in claim 1, wherein each unit in a line is aligned with another unit in all other lines, where the light-emitting units of one line provide light for different pixels than the units of other lines and at least two of the light-emitting units in each line are arranged to provide light for separate pixels on said screen.

3. A method as claimed in claim 1, wherein the line is a vertical line and the light from each light-emitting unit is displaced in a vertical direction so that the pixels of a tile are aligned vertically, and the step of displacing further includes displacing the light projected on the screen from each light-emitting unit in a horizontal direction, such that each tile also comprises horizontally aligned pixels.

4. A method as claimed in claim 1, wherein the first set of light-emitting units probes fight for all pixels of the screen.

5. A method as claimed in claim 1, wherein the step of displacing includes the step of transmitting the light of each light-emitting unit through a transmission medium.

6. A method as claimed in claim 1, wherein the step of displacing is performed in such a way that the tile of one light-emitting unit in a set slightly overlaps the tile of at least one neighbouring light-emitting unit in said set.

7. An image projection device (10) comprising:
at least one first set of light-emitting units (12; 40,42, 44) provided in an array including at least two lines of light-emitting units (1, 2, 3, 4, 5, 6, 7, 8, 9) having at least two light-emitting units each, and
a light-displacing unit (36; 48, 50; 58; 62, 64) arranged to displace the light from each light-emitting unit before projection on a screen (16), such that each light-emitting unit provides a tile (34) comprising a line including at least two pixels aligned in one direction on the screen.

8. An image projecting device as claimed in claim 7, wherein each light-emitting unit of a line is aligned with another unit in all other lines, where the light-emitting units of one line provide light for different pixels than the units of other lines and at least two of the light-emitting units in each line are arranged to provide light for separate pixels on said screen.

9. An image projection device as claimed in claim 7, further including a screen (16) onto which light from the first set of light-emitting units is projected.

10. An image projection unit as claimed in claim 7, wherein the first set of light-emitting units provides light for all pixels of the screen.

11. An image projection device (10) as claimed in claim 7, wherein the light-displacing unit comprises a first medium (34; 48; 64) which is rotatable around a first axis for providing tiles having at least two pixels aligned in a first direction on the screen.

12. An image projection device as claimed in claim 11, wherein the first medium is transmissive and the light-displacing unit (36) includes a number of segments (38) of the first medium which is rotatable around said axis, and each segment has a varying width (W) for displacing the light from a set of light-emitting units in the first direction.

13. An image projection device as claimed in claim 11, wherein the light-displacing unit (36) comprises a number of segments (38) of the first medium, each segment is provided with a first side facing the light-emitting units and providing a different angle of incidence for the light from a set of light-emitting units, such that the light from said set of light-emitting units is displaced in a second direction by each segment for providing the tiles (34) with pixels which are also aligned in the second direction.

14. An image projection device as claimed in claim 12, wherein all the segments have the same width variation.

15. An image projection device as claimed in claim 12, wherein the segments are provided as a number of prisms provided around a wheel and providing a polygonal shape to the light-displacing unit.

16. An image projection device as claimed in claim 11, wherein the light-displacing unit further comprises a second medium (50) which is rotatable around a second axis perpendicular to the first axis for displacing the light projected on the screen from each light-emitting unit in a second direction, and both the first and second mediums are transmissive.

17. An image projection device as claimed in claim 11, wherein the light-displacing unit further comprises a second medium (62) which is rotatable around a second axis perpendicular to the first axis for displacing the light projected on the screen from each light-emitting unit in a second direction, and both the first and second mediums are reflective.

18. An image projection device as claimed in claim 7, further including a second and a third set of light-emitting units (42, 44) and a transflective unit (46), wherein the transflective unit is arranged to reflect the light of the first set of light-emitting units, reflect the light of the second set of light-emitting units and transmit the light of the third set of light-emitting units.

19. An image projection device as claimed in claim 18, wherein the transflective unit is placed in such a way that the light from the different sets of light-emitting units passes the transflective unit before reaching the light-displacing unit.

20. An image projection device as claimed in claim 7, wherein the light-displacing unit is arranged in such a way that a tile slightly overlaps neighbouring tiles.

21. An image projection device as claimed in claim 7, in which it is a display.

22. An image projection device as claimed in claim 7, in which it is a projector.

23. A television set incorporating a display as claimed in claim 22.
